(19) United States
(12) Patent Application Publication
(10) Pub. No.: US 2020/0026119 A1
(43) Pub. Date: Jan. 23, 2020

(54) ELECTRONIC DEVICE AND METHOD FOR MANUFACTURING THE SAME

(71) Applicant: Japan Display Inc., Tokyo (JP)

(72) Inventors: Yoshikatsu IMAZEKI, Tokyo (JP); Yoichi KAMIJO, Tokyo (JP); Shuichi OSAWA, Tokyo (JP); Yoshihiro WATANABE, Tokyo (JP); Shoji HINATA, Tokyo (JP)

(21) Appl. No.: 16/588,461

(22) Filed: Sep. 30, 2019

Related U.S. Application Data
(63) Continuation of application No. PCT/JP2018/012854, filed on Mar. 28, 2018.

(30) Foreign Application Priority Data
Mar. 31, 2017 (JP) 2017-071542

(51) Int. Cl. G02F 1/1333; G02F 1/1343; G02F 1/1368; G09F 9/30; G02F 1/1345; G09G 3/36

(52) U.S. Cl. CPC G02F 1/133345; G02F 1/134309; G02F 1/1368; G02F 2201/123; G02F 1/13454; G09G 3/3648; G09F 9/30

(57) ABSTRACT

According to one embodiment, an electronic device includes a first substrate, a second substrate, an insulating film and a connecting material. The first substrate includes a first insulating substrate and a first conductive layer. The second substrate includes a second insulating substrate and a second conductive layer, and has a first through hole. The insulating film has a second through hole connected to the first through hole and penetrating to the first conductive layer. The connecting material is located in the first and the second through holes and electrically connects the first conductive layer and the second conductive layer. A width of the second through hole is less than a width of the first through hole.

### CROSS-REFERENCE TO RELATED APPLICATIONS

This application is a Continuation Application of PCT Application No. PCT/JP2018/012854, filed Mar. 28, 2018 and based upon and claiming the benefit of priority from Japanese Patent Application No. 2017-071542, filed Mar. 31, 2017, the entire contents of all of which are incorporated herein by reference.

### FIELD

Embodiments described herein relate generally to an electronic device and a method for manufacturing the same.

### BACKGROUND

Recently, various technologies for narrowing the frame of a display device have been considered. In one example, a technology for electrically connecting a wiring portion which comprises an in-hole connector within a hole penetrating an inner surface and an outer surface of a first substrate formed of resin and a wiring portion which is provided on an inner surface of a second substrate formed of resin by an inter-substrate connector has been disclosed.

### BRIEF DESCRIPTION OF THE DRAWINGS

FIG. 1 is a cross-sectional view showing a configuration example of a display device DSP of the present embodiment.

FIG. 2 is a cross-sectional view showing another configuration example of the display device DSP of the present embodiment.

FIG. 3 is a perspective view showing a configuration example of a contact hole V shown in FIG. 1.

FIG. 4 is a plan view of the contact hole V shown in FIG. 3.

FIG. 5A is a cross-sectional view showing another configuration example of the display device DSP of the present embodiment.

FIG. 5B is a cross-sectional view showing a state where a connecting material C is provide in the configuration example of FIG. 5A.

FIG. 6A is a cross-sectional view showing another configuration example of the display device DSP of the present embodiment.

FIG. 6B is a cross-sectional view showing a state where a connecting material C is provided in the configuration example of FIG. 6A.

FIG. 7A is an explanatory diagram showing a method for forming a through hole VA (thickness T).

FIG. 7B is an explanatory diagram showing the method for forming the through hole VA (thickness 0.8T).

FIG. 7C is an explanatory diagram showing the method for forming the through hole VA (thickness 0.6T).

FIG. 7D is an explanatory diagram showing the method for forming the through hole VA (thickness 0.4T).

FIG. 7E is an explanatory diagram showing the method for forming the through hole VA (thickness 0.2T).

FIG. 8A is an explanatory diagram showing an example of the manufacturing method for manufacturing the display device DSP (preparing a workpiece WK).

FIG. 8B is an explanatory diagram showing an example of the manufacturing method for manufacturing the display device DSP (forming a modified area MA).

FIG. 8C is an explanatory diagram showing an example of the manufacturing method for manufacturing the display device DSP (forming a concavity CC).

FIG. 8D is an explanatory diagram showing an example of the manufacturing method for manufacturing the display device DSP (expanding the concavity CC).

FIG. 8E is an explanatory diagram showing an example of the manufacturing method for manufacturing the display device DSP (forming a through hole VA).

FIG. 8F is an explanatory diagram showing an example of the manufacturing method for manufacturing the display device DSP (forming a through hole VB).

FIG. 8G is an explanatory diagram showing an example of the manufacturing method for manufacturing the display device DSP (forming a connecting material C).

FIG. 8H is an explanatory diagram showing an example of the manufacturing method for manufacturing the display device DSP (forming a second conductive layer L2).

FIG. 8I is an explanatory diagram showing an example of the manufacturing method for manufacturing the display device DSP (forming a protection film PF and bonding an optical element OD).

FIG. 9A is an explanatory diagram showing another example of the manufacturing method for manufacturing the display device DSP (forming the second conductive layer L2 and the connecting material C).

FIG. 9B is an explanatory diagram showing another example of the manufacturing method for manufacturing the display device DSP (forming the protection film PF and bonding the optical element OD).

FIG. 10 is an explanatory diagram showing a method for forming the through hole VA having the cross-sectional shape shown in FIGS. 1 and 2.

FIG. 11 is an explanatory diagram showing a method for forming the through hole VA having the cross-sectional shape shown in FIG. 5A.

FIG. 12 is an explanatory diagram showing a method for forming the through hole VA having the cross-sectional shape shown in FIG. 6A.

FIG. 13 is a plan view showing a configuration example of the display device DSP of the present embodiment.

FIG. 14 is an illustration showing the basic configuration and equivalent circuit of a display panel PNL shown in FIG. 13.

FIG. 15 is a cross-sectional view showing the structure of a part of the display panel PNL shown in FIG. 13.

FIG. 16 is a plan view showing a configuration example of a sensor SS.

FIG. 17 is an illustration showing a configuration example of a detector RS of a detection electrode Rx1 shown in FIG. 13.

FIG. 18 is a cross-sectional view showing a configuration example of the display panel PNL taken along line A-B including a contact hole V1 shown in FIG. 13.

### DETAILED DESCRIPTION

In general, according to one embodiment, there is provided an electronic device of the present embodiment comprising a first substrate, a second substrate, an insulating film and a connecting material. The first substrate comprises a first insulating substrate and a first conductive layer. The second substrate comprises a second insulating substrate having a first surface which is opposed to the first conductive layer and is separated from the first conductive layer and a second surface which is located on an opposite side to the first surface, and a second conductive layer located on the second surface, and has a first through hole penetrating the first surface and the second surface. The insulating film has a second through hole located between the first conductive layer and the second insulating substrate, connected to the first through hole and penetrating to the first conductive layer. The connecting material is located in the first through hole and the second through hole and electrically connects the first conductive layer and the second conductive layer. A width of the second through hole is less than a width of the first through hole.

According to another embodiment, there is provided a method for manufacturing an electronic device. In a workpiece comprising a first substrate comprising a first insulating substrate and a first conductive layer, a second substrate comprising a second insulating substrate, and an insulating film located between the first conductive layer and the second insulating substrate, the method comprises modifying by focusing a laser beam to an area within the second insulating substrate, thinning the second insulating substrate, removing the modified area and forming a first through hole which penetrates the second insulating substrate to the insulating film, and forming a second through hole which is connected to the first through hole and penetrates the insulating film to the first conductive layer.

Embodiments will be described hereinafter with reference to the accompanying drawings. The disclosure is merely an example, and proper changes in keeping with the spirit of the invention, which are easily conceivable by a person of ordinary skill in the art, come within the scope of the invention as a matter of course. In addition, in some cases, in order to make the description clearer, the widths, thicknesses, shapes, etc., of the respective parts are illustrated schematically in the drawings, rather than as an accurate representation of what is implemented. However, such schematic illustration is merely exemplary, and in no way restricts the interpretation of the invention. In addition, in the specification and drawings, structural elements which function in the same or a similar manner to those described in connection with preceding drawings are denoted by like reference numbers, detailed description thereof being omitted unless necessary.

In the present embodiment, a display device will be disclosed as an example of the electronic device. This display device can be used in various devices such as smartphones, tablet computers, mobile phones, notebook computers and game consoles. The main configurations disclosed in the present embodiment can be applied to liquid crystal display devices, self-luminous display devices such as organic electroluminescent display devices, electronic paper display devices comprising electrophoretic elements, etc., display devices employing micro electromechanical systems, display devices employing electrochromism, and the like.

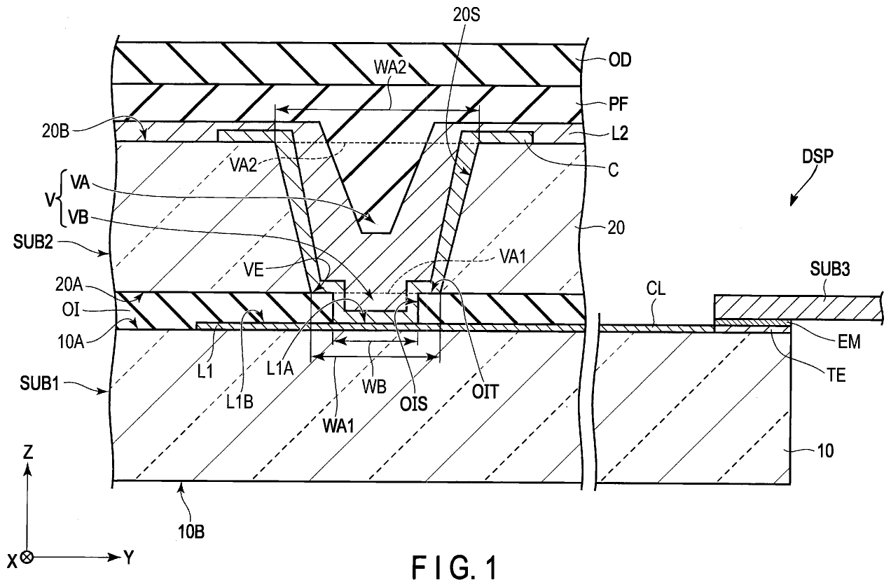

FIG. 1 is a cross sectional view showing a configuration example of the display device DSP of the present embodiment. A first direction X, a second direction Y and a third direction Z are orthogonal to each other here but may cross each other at an angle other than 90 degrees. The first direction X and the second direction Y correspond to directions parallel to the surface of a substrate which constitutes the display devices DSP, and the third direction Z corresponds to a thickness direction of the display device DSP. Here, the cross-section of a part of the display device DSP in a Y-Z plane defined by the second direction Y and the third direction Z is illustrated.

The display device DSP comprises a first substrate SUB1, a second substrate SUB2, an insulating film OI, a connecting material C and a wiring substrate SUB3. The first substrate SUB1 and the second substrate SUB2 are opposed to each other in the third direction Z. In the following description, a direction from the first substrate SUB1 toward the second substrate SUB2 will be referred to as upward (or simply above) and a direction from the second substrate SUB2 toward the first substrate SUB1 will be referred to as downward (or simply below). In addition, viewing from the second substrate SUB2 toward the first substrate SUB1 will be described as viewing planarly. Furthermore, viewing a cross-section of the display device DSP in the Y-Z plane of FIG. 1 (or, although not illustrated in the drawing, an X-Z plane defined by the first direction X and the third direction Z) will be referred to as viewing cross-sectionally.

The first substrate SUB1 comprises a first insulating substrate 10 and a first conductive layer L1 located on a side of the first insulating substrate 10 which is opposed to the second substrate SUB2. The first insulating substrate 10 has a surface 10A opposed to the second substrate SUB2 and a surface 10B on a side opposite to the surface 10A. In the example illustrated, the first conductive layer L1 is located on the surface 10A. Although not illustrated in the drawing, various insulating films and various conductive films may be disposed between the first insulating substrate 10 and the first conductive layer L1 or on the first conductive layer L1.

The second substrate SUB2 comprises a second insulating substrate 20 and a second conductive layer L2. The second insulating substrate 20 has a surface (first surface) 20A opposed to the first substrate SUB1 and a surface (second surface) 20B on a side opposite to the surface 20A. Regarding the second insulating substrate 20, the surface 20A is opposed to the first conductive layer L1 and is separated from the first conductive layer L1 in the third direction Z. In the example illustrated, the second conductive layer L2 is located on the surface 20B. The first insulating substrate 10, the first conductive layer L1, the second insulating substrate 20 and the second conductive layer L2 are arranged in the third direction Z in this order. The insulating film OI is located between the first conductive layer L1 and the second insulating substrate 20. Note that another conductive layer or air layer may be located between the first conductive layer L1 and the second insulating substrate 20. In addition, although not illustrated in the drawing, various insulating films or various conductive films may be disposed between the second insulating substrate 20 and the second conductive layer L2 or on the second conductive layer L2.

Each of the first insulating substrate 10 and the second insulating substrate 20 is a glass substrate formed of alkali-free glass, for example. Each of the first conductive layer L1 and the second conductive layer L2 may be formed of a metal material such as molybdenum, tungsten, titanium, aluminum, silver, copper or chromium, an alloy of these metal materials, or a transparent conductive material such as indium tin oxide (ITO) or indium zinc oxide (IZO), and may have a single layer structure or a multilayer structure. The connecting material C contains a metal material such as silver and should preferably contain fine particles whose particle diameter is of the order of several nanometers to several tens of nanometers. The insulating film OI is, for example, an organic insulating film including a light-shielding layer, a color filter, an overcoat layer, an alignment film, a sealant bonding the first substrate SUB1 and the second substrate SUB2 together and the like which will be described later, but the insulating film OI may include an inorganic insulating film.

The wiring substrate SUB3 is electrically connected to a terminal TE of the first substrate SUB1 via a conductive material EM. The terminal TE is electrically connected to the first conductive layer L1 via a wiring line CL. The wiring substrate SUB3 is, for example, a flexible substrate having flexibility. A flexible substrate applicable to the present embodiment only needs to comprise a flexible portion formed of a bendable material in at least a part of the flexible substrate. For example, the wiring substrate SUB3 of the present embodiment may be a flexible substrate whose entirety is constituted as a flexible portion or a rigid-flexible substrate which comprises a rigid portion formed of a rigid material such as glass epoxy and a flexible portion formed of a bendable material such as polyimide.

Here, a structure of connection between the first conductive layer L1 and the second conductive layer L2 in the present embodiment will be described in detail.

The display device DSP comprises a contact hole V for connecting the first conductive layer L1 and the second conductive layer L2. The contact hole V comprises a through hole (first through hole) VA provided in the second substrate SUB2 and a through hole (second through hole) VB provided in the insulating film OI. The through hole VB and the through hole VA are arranged in the third direction Z in this order, are located on the same straight line in the third direction Z and constitute the contact hole V. The contact hole V is formed by emitting a laser beam from the upper side of the second substrate SUB2 or by etching.

The through hole VA penetrates between the surface 20A and the surface 20B in the second insulating substrate 20. In addition, the through hole VA comprises a first portion VA1 along the surface 20A and a second portion VA2 along the surface 20B. That is, the first portion VA1 is located in the surface 20A and the second portion VA2 is located in the surface 20B. In other words, the first portion VA1 is an interface of the through hole VA at the surface 20A and the second portion VA2 is an interface of the through hole VA at the surface 20B. The first portion VA1 has a width WA1 and the second portion VA2 has a width WA2. The term width here is a length in the second direction Y in the Y-Z plane. In the example illustrated, the width WA1 is less than the width WA2. When cross-sectionally viewed, the through hole VA has such a cross-sectional shape that the width increases toward the upper side in the third direction Z (that is, from the surface 20A toward the surface 20B). In the through hole VA having such a cross-sectional shape, the width WA1 corresponds to the minimum width of the through hole VA. Note that, as will be described later, the through hole VA may have such a cross-sectional shape that the width decreases toward the upper side in the third direction Z. In this case, the width WA2 corresponds to the minimum width of the through hole VA. Alternatively, as will be described later, the through hole VA may have such a cross-sectional shape that the width hardly changes toward the upper side in the third direction Z. In that case, the width WA1 and the width WA2 are substantially the same and both correspond to the minimum width of the through hole VA.

The through hole VB is connected to the through hole VA and penetrates to the first conductive layer L1 in the insulating film OI. The through hole VB has a width WB. Although the through hole VB has such a cross-sectional shape that the width hardly changes toward the upper side in the third direction Z in the example illustrated, the through hole VB may have such a cross-sectional shape that the width varies in one of the upper portion, the lower portion and the intermediate portion. In any case, the width WB of the through hole VB in the present embodiment corresponds to the width of the uppermost portion in the through hole VB. The width WB is less than the width of any portion of the through hole VA, and needless to say, the width WB is less than the width WA1 which is the minimum width of the through hole VA in the example illustrated. In addition, the through hole VB is located at the center of the first portion VA1. The insulating film OI comprises an upper surface (first upper surface) OIT located between an edge VE of the first portion VA1 and the through hole VB. That is, the upper surface OIT corresponds to a portion which is not covered with the second insulating substrate 20.

The first conductive layer L1 comprises an upper surface (second upper surface) L1A which is not covered with the insulating film OI and an upper surface L1B which is covered with the insulating film OI. In the example illustrated, no through hole is formed in the first conductive layer L1.

The connecting material C is located in the through hole VA and the through hole VB and electrically connects the first conductive layer L1 and the second conductive layer L2. In the example illustrated, the connecting material C is in contact with each of the surface 20B of the second insulating substrate 20 and an inner surface 20S of the second insulating substrate 20 in the through hole VA. In addition, the connecting material C is in contact with each of the upper surface OIT and an inner surface OIS of the insulating film OI. Furthermore, the connecting material C is in contact with the upper surface L1A of the first conductive layer L1.

The second conductive layer L2 is located on the surface 20B and is in contact with the connecting material C. In the example illustrated, the second conductive layer L2 is located also in the through hole VA and the through hole VB and is in contact with the connecting material C. In the through hole VA, the connecting material C is located between the second insulating substrate 20 (or the inner surface 20S) and the second conductive layer L2. In the through hole VB, the connecting material C is located between the insulating film OI (or the inner surface OIS) and the second conductive layer L2.

The second conductive layer L2 is electrically connected to the wiring substrate SUB3 via the connecting material C and the first conductive layer L1 by the above-described connection structure. As a result, a control circuit for writing a signal to the second conductive layer L2 and reading a signal output from the second conductive layer L2 can be connected to the second conductive layer L2 via the wiring substrate SUB3.

A protection film PF covers the second conductive layer L2. In addition, a hollow portion which is not filled with the connecting material C or the second conductive layer L2 in the through hole VA is filled with the protection film PF. An optical element OD including a polarizer, etc., is bonded to the protection film PF. The protection film PF is formed of, for example, an organic insulating material such as acrylic resin.

According to the present embodiment, the second conductive layer L2 provided in the second substrate SUB2 is electrically connected to the first conductive layer L1 provided in the first substrate SUB1 via the connecting material C of the contact hole V. Therefore, it is unnecessary to provide a wiring line and a wiring substrate for writing a signal to the second conductive layer L2 and reading a signal output from the second conductive layer L2 in the second substrate SUB2. Consequently, the substrate size of the second substrate SUB2 can be reduced and the width of the periphery of the display device DSP can be reduced in an X-Y plane defined by the first direction X and the second direction Y. In addition, as compared to a case where a wiring substrate is provided in the second substrate SUB2, the cost can be reduced. As a result, it becomes possible to achieve a narrow frame and cost reduction.

In addition, the connecting material C and the second conductive layer L2 are located in the through hole VA, and these two are in contact with each other. Therefore, as compared to a case where only one of the connecting material C and the second conductive layer L2 is located in the through hole VA, the area of contact between the connecting material C and the second conductive layer L2 can be increased. As a result, a connection failure between the connecting material C and the second conductive layer L2 can be prevented.

Furthermore, no through hole is formed in the first conductive layer L1, and the upper surface L1A of the first conductive layer L1 comes out of the insulating film OI and becomes exposed in the through hole VB. Regarding the first conductive layer L1, the upper surface L1A is in contact with at least one of the connecting material C and the second conductive layer L2. Therefore, as compared to a case where a through hole is formed in the first conductive layer L1, the area of contact between the first conductive layer L1 and at least one of the connecting material C and the second conductive layer L2 can be increased. Consequently, a connection failure between the first conductive layer L1 and the second conductive layer L2 can be prevented.

Furthermore, the width WB of the through hole VB is less than the width WA1 of the through hole VA. The insulating film OI comprises the upper surface OTT which is not covered with the second insulating substrate 20. Accordingly, at the time of forming the connecting material C and the second conductive layer L2, when conductive materials for forming them are injected into the through hole VA, the conductive materials can be held on the upper surface OTT, and the connecting material C and the second conductive layer L2 can be prevented from being disconnected.

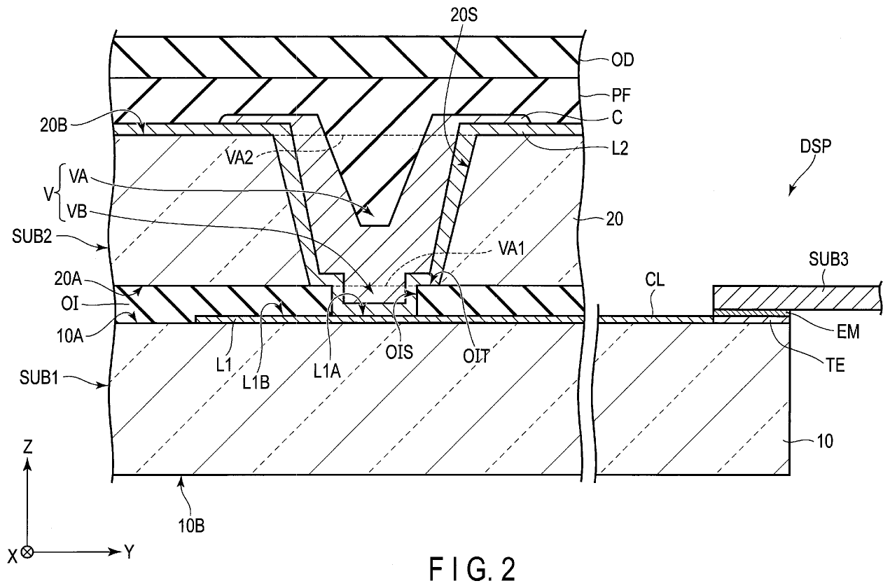

FIG. 2 is a cross-sectional view showing another configuration example of the display device DSP of the present embodiment.

The configuration example shown in FIG. 2 differs from the configuration example shown in FIG. 1 in that the second conductive layer L2 is located below the connecting material C. That is, the second conductive layer L2 is located in the through hole VA and the through hole VB. In the example illustrated, the second conductive layer L2 is in contact with each of the surface 20B and the inner surface 20S. In addition, the second conductive layer L2 is in contact with each of the upper surface OIT and the inner surface OIS. Furthermore, the second conductive layer L2 is in contact with the upper surface L1A.

The connecting material C is located on the surface 20B and is in contact with the second conductive layer L2. In the example illustrated, the connecting material C is located also in the through hole VA and the through hole VB and is in contact with the second conductive layer L2. In the through hole VA, the second conductive layer L2 is located between the second insulating substrate 20 (or the inner surface 20S) and the connecting material C. In the through hole VB, the second conductive layer L2 is located between the insulating film OI (or the inner surface OIS) and the connecting material C. The connecting material C is covered with the protection film PF.

In this configuration example also, the same advantages as the above-described configuration example can be obtained. In addition, even if the second conductive layer L2 is disconnected in the contact hole V, since the connecting material C is located in the contact hole V and is in contact with the second conductive layer L2, the connecting material C can electrically connect the first conductive layer L1 and the second conductive layer L2. If the second conductive layer L2 can be in contact with the first conductive layer L1 without being disconnected in the contact hole V, the connecting material C may be omitted.

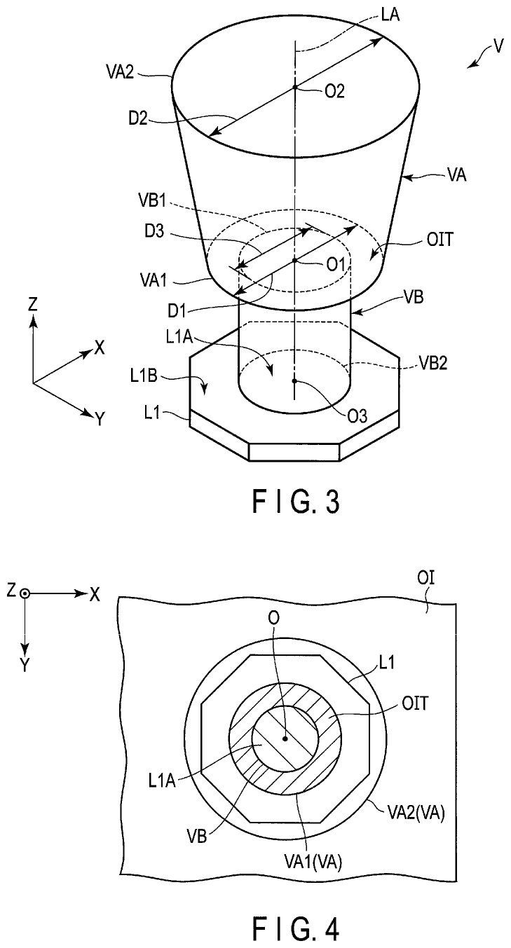

FIG. 3 is a perspective view showing a configuration example of the contact hole V shown in FIG. 1.

The first portion VA1 corresponds to a lower hole of the through hole VA and the second portion VA2 corresponds to an upper hole of the through hole VA. In the example illustrated, each of the first portion VA1 and the second portion VA2 is formed in a circular shape in the X-Y plane. The area of the first portion VA1 is less than the area of the second portion VA2. In addition, a diameter D1 of the first portion VA1 is less than a diameter D2 of the second portion VA2. The term diameter here corresponds to a length in the first direction X. In one example, the diameter D2 is two to four times greater than the diameter D1.

A third portion VB1 corresponds to an upper hole of the through hole VB and a fourth portion VB2 corresponds to a lower hole of the through hole VB. In the example illustrated, each of the third portion VB1 and the fourth portion VB2 is formed in a circular shape in the X-Y plane. A diameter D3 of the third portion VB1 is less than the diameter D1. The upper surface OIT is formed in a ring shape in the X-Y plane around the third portion VB1. Regarding the first conductive layer L1, the upper surface L1A overlaps the fourth portion VB2 and is formed in a circular shape in the X-Y plane.

In the example shown in FIG. 3, a center O1 of the first portion VA1 and a center O2 of the second portion VA2 are located on a same straight line LA parallel to the third direction Z. In addition, the center O1 matches the center of the third portion VB1. Furthermore, a center O3 of the fourth portion VB2 is located on the same straight line LA as the centers O1 and O2.

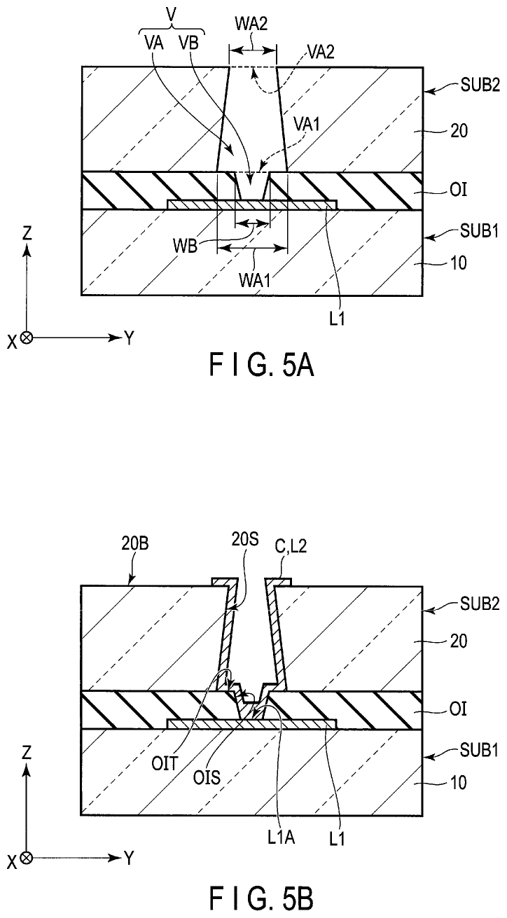

FIG. 4 is a plan view of the contact hole V shown in FIG. 3. Here, the first conductive layer L1 is assumed to correspond to a pad which will be described later, and a wiring line connected to the first conductive layer L1, a wiring line provided around the first conductive layer L1 and the like are not illustrated. In the example illustrated, the first conductive layer L1 is formed in an octagon shape in the X-Y plane.

Here, attention will be focused on the positional relationship between the first conductive layer L1 and the through holes VA and VB. When planarly viewed (in the X-Y plane), each of the first portion VA1 and the through hole VB is formed in the shape of a circle whose diameter is less than the width of the first conductive layer L1 in the first direction X and the second direction Y and is located at substantially the center of the first conductive layer L1. The second portion VA2 is larger than the first portion VA1, and is larger than the first conductive layer L1 in the example illustrated. The upper surface OIT corresponds to a ring-shaped area indicated by diagonal lines slanting upward to the right. The upper surface L1A corresponds to a circular area indicated by diagonal lines slanting downward to the right. The upper surface OIT and the upper surface L1A are in contact with the connecting material C in the example shown in FIG. 1 and are in contact with the second conductive layer L2 in the example shown in FIG. 2. Note that the upper surface OIT and the upper surface L1A may be in contact with both the connecting material C and the second conductive layer L2 in some cases. The first portion VA1, the second portion VA2, the through hole VB and the upper surface L1A are circular when viewed planarly, and are formed concentrically and share a center O with each other.

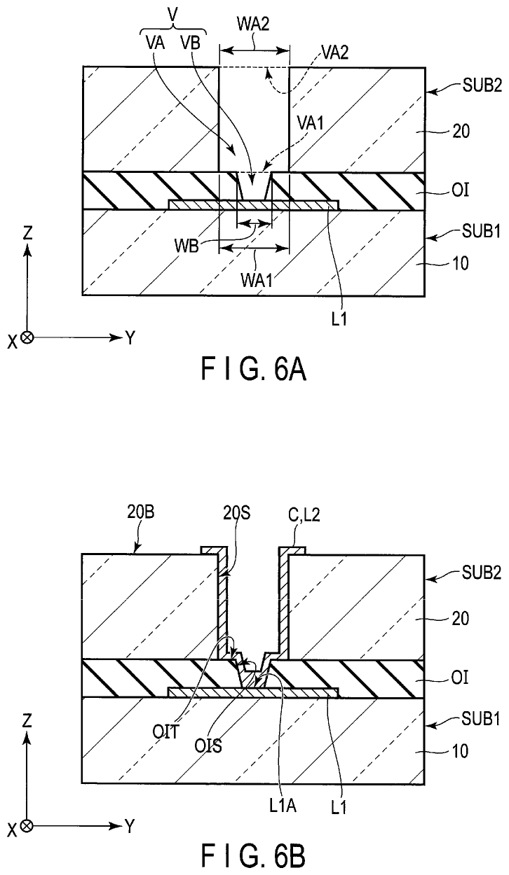

FIG. 5A is a cross-sectional view showing another configuration example of the display device DSP of the present embodiment.

The configuration example shown in FIG. 5A differs from the configuration example shown in FIG. 1 in that, when cross-sectionally viewed (in the Y-Z plane), the through hole VA has such a cross-sectional shape that the width decreases toward the upper side in the third direction Z. That is, the width WA1 of the first portion VA1 is greater than the width WA2 of the second portion VA2 in the Y-Z plane. In the through hole VA having such a cross-sectional shape, the width WA2 corresponds to the minimum width of the through hole VA. The width WB of the through hole VB is less than the width WA2. Although the cross-sectional shape in the Y-Z plane has been described with reference to FIG. 5A, the same applies to the shape in the X-Z plane.

FIG. 5B is a cross-sectional view showing a state where the connecting material C is provided in the configuration example of FIG. 5A.

The connecting material C is in contact with the surface 20B and the inner surface 20S of the second insulating substrate 20, is in contact with the upper surface OIT and the inner surface OIS of the insulating film OI and is in contact with the upper surface L1A of the first conductive layer L1. Note that the illustrated connecting material C can be interchanged with the second conductive layer L2, as is the case with the configuration example shown in FIG. 2.

In this configuration example also, the same advantages as the above-described configuration example can be obtained.

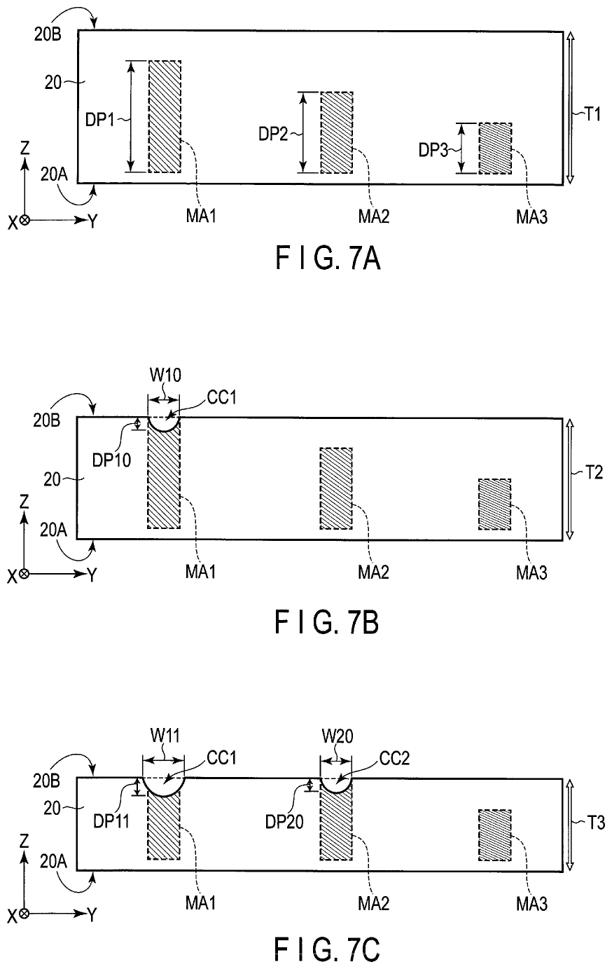

FIG. 6A is a cross-sectional view showing another configuration example of the display device DSP of the present embodiment.

The configuration example shown in FIG. 6A differs from the configuration example shown in FIG. 1 in that, when cross-sectionally viewed (in the Y-Z plane), the through hole VA has such a cross-sectional shape that the width hardly changes toward the upper side in the third direction Z. That is, the width WA1 of the first portion VA1 is substantially the same as the width WA2 of the second portion VA2 in the Y-Z plane. In the through hole VA having such a cross-sectional shape, the widths WA1 and WA2 correspond to the minimum width of the through hole VA. The width WB of the through hole VB is less than the widths WA1 and WA2. Although the cross-sectional shape in the Y-Z plane is described with reference to FIG. 6A, the same applies to the shape in the X-Z plane.

FIG. 6B is a cross-sectional view showing a state where the connecting material C is provided in the configuration example of FIG. 6A.

The connecting material C is in contact with the surface 20B and the inner surface 20S of the second insulating substrate 20, is in contact with the upper surface OIT and the inner surface OIS of the insulating film OI and is in contact with the upper surface L1A of the first conductive layer L1. Note that the illustrated connecting material C can be interchanged with the second conductive layer L2, as is the case with the configuration example shown in FIG. 2.

In this configuration example also, the same advantages as the above-described configuration example can be obtained.

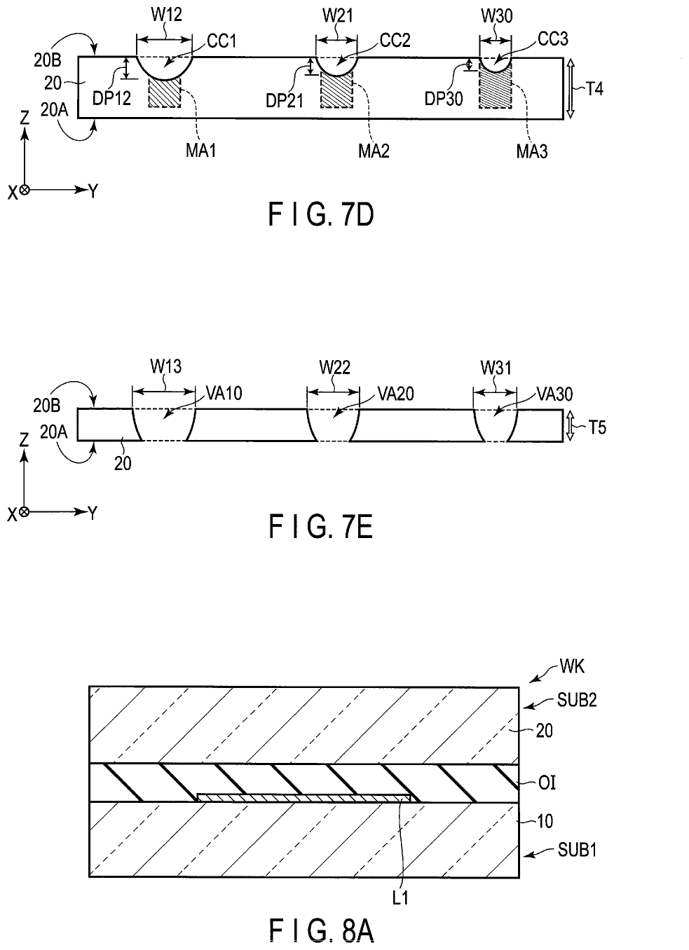

Next, an example of the method for forming the through hole VA will be described with reference to FIGS. 7A to 7E.

FIG. 7A is a cross-sectional view in the Y-Z plane of the second insulating substrate 20. The second insulating substrate 20 has a thickness T1 in the third direction Z. A laser beam is emitted from the surface 20B side of the second insulating substrate 20, and the laser beam is focused to areas MA (MA1 to MA3) within the second insulating substrate 20. As the light source, a femtosecond laser which emits a laser beam having a pulse width of femtoseconds is suitable because the femtosecond laser hardly causes thermal or chemical damage to the periphery of a portion to which the laser beam is focused.

The areas MA1 to MA3 are modified by being irradiated with the above-described laser beam. All the modified areas MA1 to MA3 are located between the surfaces 20A and 20B and are separated from the surfaces 20A and 20B. The area MA1 has a depth DP1, the area MA2 has a depth DP2, and the area MA3 has a depth DP3. The term depth here is a length in the third direction Z. The depth DP2 is less than the depth DP1, and the depth DP3 is less than the depth DP2. Furthermore, the area MA2 is closer to the surface 20B than the area MA3 is to the surface 20B in the third direction Z, and the area MA1 is closer to the surface 20B than the area MA2 is to the surface 20B in the third direction Z.

Subsequently, the surface 20B of the second insulating substrate 20 is thinned by etching, etc. FIG. 7B shows a state where the thickness of the second insulating substrate 20 is reduced to T2 (<T1). The second insulating substrate 20 is a glass substrate, for example, and is dissolved and thinned by an etching solution such as a hydrofluoric acid (HF) solution. Furthermore, the modified areas MA1 to MA3 dissolve more easily than glass in the above-described etching solution. In the example shown in FIG. 7B, as the thickness of the second insulating substrate 20 is reduced, the area MA1 is exposed to the etching solution, and a concavity CC1 which is recessed from the surface 20B is formed. The concavity CC1 shown in FIG. 7B has a width W10 and a depth DP10.

FIG. 7C shows a state where the surface 20B of the second insulating substrate 20 is further etched and the thickness of the second insulating substrate 20 is reduced to T3 (<T2). In the example illustrated, as the thickness of the second insulating substrate 20 is reduced, the area MA2 is exposed to the etching solution, and a concavity CC2 which is recessed from the surface 20B is formed. The concavity CC2 shown in FIG. 7C has a width W20 and a depth DP20. Since the area MA1 is continuously exposed to the etching solution, the concavity CC1 is expanded. The concavity CC1 shown in FIG. 7C has a width W11 which is greater than the width W10 and has a depth DP11 which is greater than the depth DP10.

FIG. 7D shows a state where the surface 20B of the second insulating substrate 20 is further etched and the thickness of the second insulating substrate 20 is reduced to T4 (<T3). In the example illustrated, as the thickness of the second insulating substrate 20 is reduced, the area MA3 is exposed to the etching solution, and a concavity CC3 which is recessed from the surface 20B is formed. The concavity CC3 shown in FIG. 7D has a width W30 and a depth DP30. Since the areas MA1 and MA2 are continuously exposed to the etching solution, and the concavities CC1 and CC2 are expanded, respectively. The concavity CC1 shown in FIG. 7D has a width W12 which is greater than the width W11 and has a depth DP12 which is greater than the depth DP11. The concavity CC2 shown in FIG. 7D has a width W21 which is greater than the width W20 and has a depth DP21 greater than the depth DP20.

FIG. 7E shows a state where the surface 20B of the second insulating substrate 20 is further etched and the thickness of the second insulating substrate 20 is reduced to T5 (<T4). In the example illustrated, as the thickness of the second insulating substrate 20 is reduced, the areas MA1 to MA3 are exposed to the etching solution, and the concavity CC1 is expanded and turns to a through hole VA10 which penetrates from the surface 20B to the surface 20A. Similarly, the concavity CC2 turns to a through hole VA20, and the concavity CC3 turns to a through hole VA30. A width W13 of the through hole VA10 is greater than the width W12, a width W22 of the through hole VA20 is greater than the width W21 and a width W31 of the through hole VA30 is greater than the width W30 in the Y-Z plane. Furthermore, the width W22 is greater than the width W31 and the width W13 is greater than the width W22.

As described above, the areas MA1 to MA3 which are modified beforehand are formed within the second insulating substrate 20, and as a result, through holes can be formed with the areas MA1 to MA3 as the starting points, in accordance with the thickness reduction of the second insulating substrate 20 by the etching of the second insulating substrate 20. In addition, the widths and depths of the through holes can be adjusted in accordance with the depths, widths and positions of the areas MA1 to MA3. Although the shape in the Y-Z plane has been described with reference to FIGS. 7A to 7E, the same applies to the shape in the X-Y plane. It is because the energy distribution in the X-Y plane of the laser beam of the present embodiment is isotropic about one point.

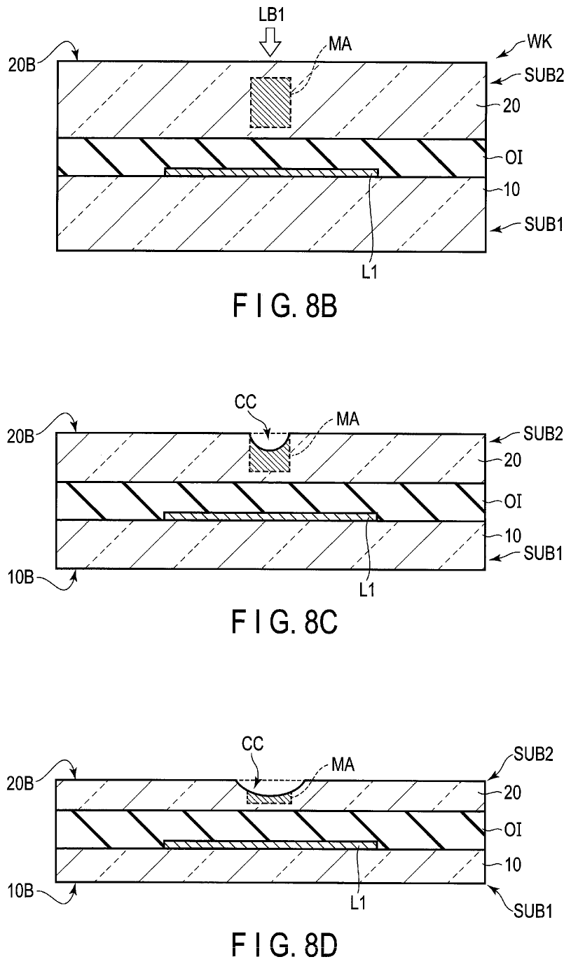

Next, an example of the manufacturing method for manufacturing the display device DSP of the configuration example shown in FIG. 1 will be described with reference to FIGS. 8A to 8I.

Firstly, as shown in FIG. 8A, a workpiece WK comprising the first substrate SUB1 including the first insulating substrate 10 and the first conductive layer L1, the second substrate SUB2 including the second insulating substrate 20, and the insulating film OI located between the first conductive layer L1 and the second insulating substrate 20 is prepared. Each of the first insulating substrate 10 and the second insulating substrate 20 is a glass substrate.

Subsequently, as shown in FIG. 8B, a laser beam LB1 is emitted from the surface 20B side of the workpiece WK, and the laser beam is focused to an area MA within the second insulating substrate 20. As the light source here, a femtosecond laser which emits a laser beam having a pulse width of femtoseconds is suitable because the femtosecond laser hardly causes thermal or chemical damage to the periphery of a portion to which the laser beam is focused.

Subsequently, as shown in FIG. 8C, the second insulating substrate 20 is thinned and the first insulating substrate 10 is thinned. More specifically, the surface 10B of the first insulating substrate 10 and the surface 20B of the second insulating substrate 20 are introduced into an etching solution, and the thickness of the first insulating substrate 10 and the thickness of the second insulating substrate 20 are reduced, respectively. In the example illustrated, as the thickness of the second insulating substrate 20 is reduced, the area MA is exposed to the etching solution, a portion which is close to the surface 20B in the area MA is removed, and a concavity CC which is recessed from the surface 20B is formed. Then, as shown in FIG. 8D, the first insulating substrate 10 and the second insulating substrate 20 are further etched. As the thickness of the second insulating substrate 20 is further reduced, the concavity CC is expanded. Then, as shown in FIG. 8E, the first insulating substrate 10 and the second insulating substrate 20 are further etched. As the thickness of the second insulating substrate 20 is further reduced, the area MA is exposed to the etching solution, and the concavity CC is further expanded and turns to the through hole VA which penetrates from the surface 20B to the insulating film OI. As described above, the through hole VA is formed by isotropically etching the second insulating substrate 20. Therefore, in one example, the first portion VA1 and the second portion VA2 are concentrically formed as described above with reference to FIG. 4. Furthermore, for example, as compared to a case where the through hole VA is formed by emitting a laser beam with a long pulse width of the order of a nanosecond or more and thermally dissolving the second insulating substrate 20, the second insulating substrate 20 is less damaged, and residue is hardly left around the through hole VA and not many bumps are created.

Subsequently, as shown in FIG. 8F, the through hole VB which is connected to the through hole VA and penetrates the insulating film OI to the first conductive layer L1 is formed. In one example, a laser beam LB2 is emitted from the surface 20B side of the workpiece WK, the insulating film OI exposed from the through hole VA is removed, and the through hole VB is formed. The laser beam LB2 should preferably be emitted to the extent of penetrating the insulating film OI which mainly includes an organic insulating film but not to the extent of penetrating the first conductive layer L1.

Subsequently, as shown in FIG. 8G the connecting material C which is located in the through holes VA and VB and is in contact with the first conductive layer L1 is formed. In one example, the connecting material C containing a solvent is injected into the through holes VA and VB and is brought into contact with the first conductive layer L1, and then the solvent is removed. As a result, the connecting material C which is in contact with each of the second insulating substrate 20, the insulating film OI and the first conductive layer L1 is formed.

Subsequently, as shown in FIG. 8H, the second conductive layer L2 which is in contact with the connecting material C is formed. At this time, the second conductive layer L2 is formed on the surface 20B, and the through holes VA and VB is filled with the second conductive layer L2.

Subsequently, as shown in FIG. 8I, the protection film PF is formed on the second conductive layer L2, and then the optical element OD is bonded to the protection film PF. A level difference resulting from the contact hole V is moderated by the protection film PF. Therefore, when the optical element OD is bonded, detachment of the optical element OD due to the level difference of the base of the optical element OD can be prevented.

The display device DSP shown in FIG. 1 can be manufactured by the above-described steps.

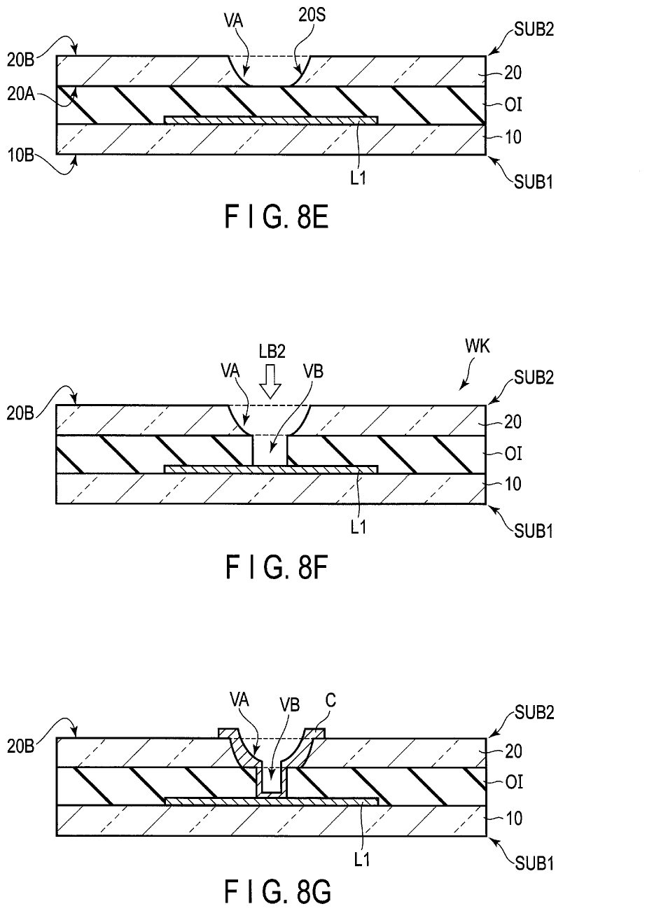

Next, an example of the manufacturing method for manufacturing the display device DSP of the configuration example shown in FIG. 2 will be described with reference to FIGS. 9A and 9B. Note that the following manufacturing method is the same as the above manufacturing method in the steps described with reference to FIGS. 8A to 8F, that is, the steps until the through holes VA and VB are formed.

As shown in FIG. 9A, the second conductive layer L2 which is located in the through holes VA and VB and is in contact with the first conductive layer L1 is formed. The second conductive layer L2 is in contact with each of the second insulating substrate 20, the insulating film OI and the first conductive layer L1. Then, the connecting material C which is in contact with the second conductive layer L2 is formed. The through holes VA and VB are filled with the connecting material C.

Subsequently, as shown in FIG. 9B, the protection film PF is formed on the connecting material C and the second conductive layer L2 and then the optical element OD is bonded to the protection film PF.

The display device DSP shown in FIG. 2 can be manufactured by the above-described steps.

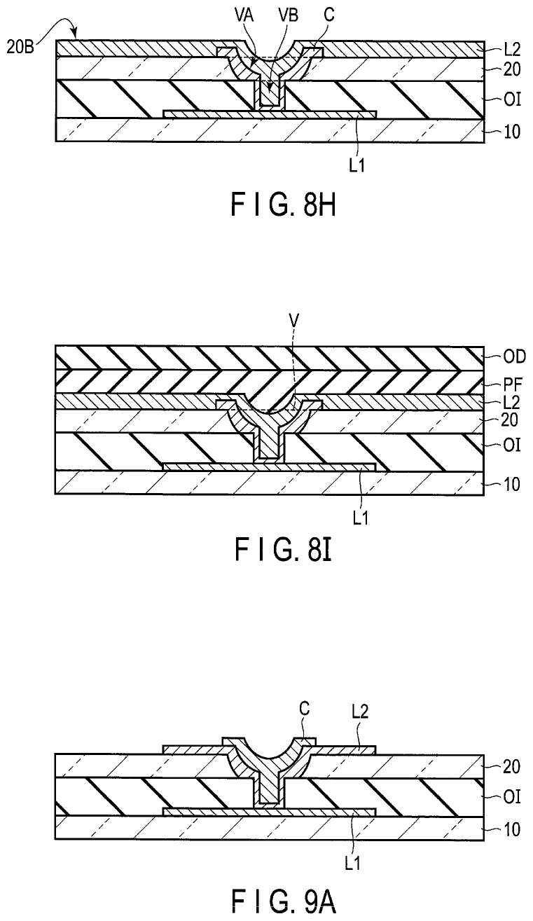

FIG. 10 is an explanatory diagram showing a method for forming the through hole VA having the cross-sectional shape shown in FIGS. 1 and 2.

An area MA11 located within the second insulating substrate 20 has a substantially-rectangular cross-sectional shape elongated in the third direction Z in the Y-Z plane. A position FP to which a laser beam is focused at the time of forming the area MA11 is indicated by an ellipse elongated in the third direction Z. Here, three ellipses each of which indicates the focus position FP are arranged in the third direction Z. It means that the focus position FP of the laser beam is moved in the third direction Z. The area MA11 is not necessarily formed of a line of areas by moving the focus position FP in the third direction Z but may be formed of lines of areas.

When the area MA11 having such a rectangular cross-sectional shape is formed, as the second insulating substrate 20 is etched from the surface 20B side, removal by etching is promoted on the upper side (side close to the surface 20B) of the area MA11 as compared to the lower side (side close to the surface 20A) of the area MA11. Therefore, the through hole VA formed with the area MA11 as the starting point has such a cross-sectional shape that the width in the second direction Y increases toward the upper side in the third direction Z as shown in FIG. 1, etc.

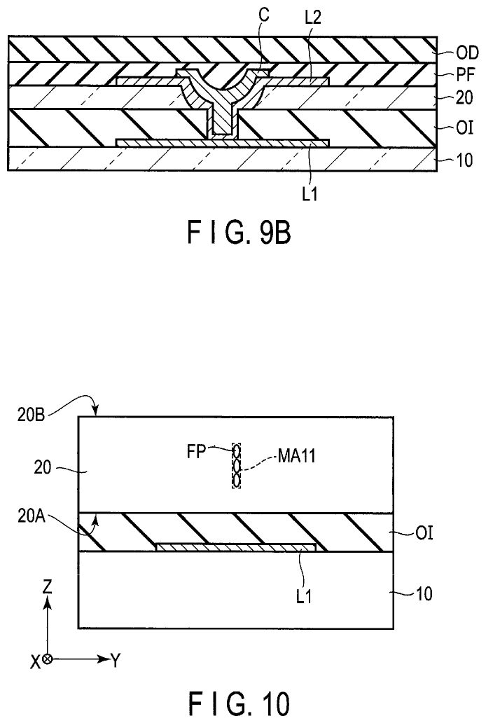

FIG. 11 is an explanatory diagram showing a method for forming the through hole VA having the cross-sectional shape shown in FIG. 5A.

An area MA 12 located within the second insulating substrate 20 has such a cross-sectional shape that a portion MA121 having a triangular shape and a portion MA122 having a rectangular shape elongated in the third direction Z are connected to each other in the third direction Z in the Y-Z plane. The portion MA121 is located on the lower side of the area MA12, and the portion MA122 is located on the upper side of the area MA12. The portion MA121 is formed by moving the focus position FP in the second direction Y (or in the X-Y plane). The portion MA122 is formed by moving the focus position FP in the third direction Z.

When the area MA12 having such a cross-sectional shape is formed, as the second insulating substrate 20 is etched from the surface 20B side, removal by etching is promoted in the portion MA121 of the area MA12 as compared to the portion MA122 of the area MA12. Therefore, the through hole VA formed with the area MA12 as the starting point has such a cross-sectional shape that the width in the second direction Y decreases toward the upper side in the third direction Z as shown in FIG. 5A, etc.

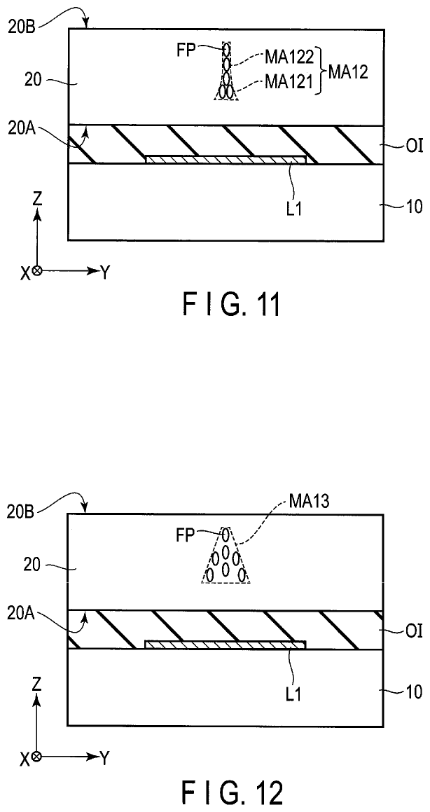

FIG. 12 is an explanatory diagram showing a method for forming the through hole VA having the cross-sectional shape shown in FIG. 6A.

An area MA13 located within the second insulating substrate 20 has such a triangular cross-sectional shape that the width in the second direction Y decreases toward the upper side in the third direction Z in the Y-Z plane. The area MA13 is formed by moving the focus position FP in the second direction Y (or in the X-Y plane) while moving the focus position FP in the third direction Z.

When the area MA 13 having such a cross-sectional shape is formed, as the second insulating substrate 20 is etched from the surface 20B side, the upper side and the lower side of the area MA13 are equally removed. Therefore, the through hole VA formed with the area MA13 as the starting point has such a cross-sectional shape that the width hardly changes toward the upper side in the third direction Z as shown in FIG. 6A, etc.

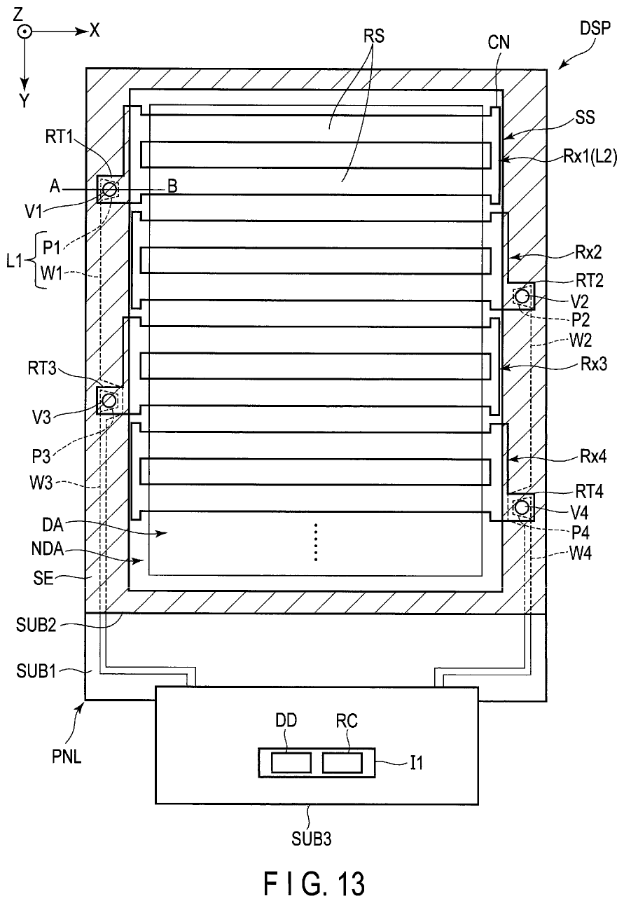

FIG. 13 is a plan view showing a configuration example of the display device DSP of the present embodiment. Here, a liquid crystal display device equipped with a sensor SS will be described as an example of the display device DSP.

The display device DSP comprises a display panel PNL, an IC chip I1, the wiring substrate SUB3 and the like. The display panel PNL is a liquid crystal panel and comprises the first substrate SUB1, the second substrate SUB2, a sealant SE and a liquid crystal layer LC which will be described later. The second substrate SUB2 is opposed to the first substrate SUB1. The sealant SE corresponds to a portion indicated by diagonal lines slanting upward to the right in FIG. 13 and bonds the first substrate SUB1 and the second substrate SUB2 together.

The display panel PNL comprises a display area DA in which an image is displayed and a frame-shaped non-display area NDA which surrounds the display area DA. The display area DA corresponds to a first area, for example, and is surrounded by and located inside the sealant SE. The non-display area NDA corresponds to a second area adjacent to the display area (first area) DA, for example. The sealant SE is located in the non-display area NDA.

The IC chip I1 is mounted on the wiring substrate SUB3. Unlike in the example illustrated, the IC chip I1 may be mounted on the first substrate SUB1 which extends on the outer side of the second substrate SUB2 or may be mounted on an external circuit board which is connected to the wiring substrate SUB3. The IC chip I1 comprises, for example, a built-in display driver DD which outputs a signal necessary for displaying an image. The display driver DD described here includes at least a part of a signal line drive circuit SD, a scanning line drive circuit GD and a common electrode drive circuit CD which will be described later. In the example illustrated, the IC chip I1 comprises a built-in detection circuit RC which functions as a touch panel controller or the like. The detection circuit RC may be incorporated in an IC chip other than the IC chip I1.

The display panel PNL may be any one of a transmissive display panel having a transmissive display function of displaying an image by selectively transmitting light from the lower side of the first substrate SUB1, a reflective display panel having a reflective display function of displaying an image by selectively reflecting light from the upper side of the second substrate SUB2, and a transflective display panel having the transmissive display function and the reflective display function, for example.

The sensor SS is configured to perform sensing for detecting contact or approach of an object to be detected to the display device DSP. The sensor SS comprises a plurality of detection electrodes Rx (Rx1, Rx2 . . . ). The detection electrodes Rx are provided in the second substrate SUB2 and correspond to the above-described second conductive layer L2. The detection electrodes Rx extend in the first direction X and are arranged to be spaced apart from each other in the second direction Y. Although FIG. 13 shows detection electrodes Rx1 to Rx4 as the detection electrodes Rx, an example of the structure will be described by focusing on the detection electrode Rx1.

That is, the detection electrode Rx comprises a detector RS, a terminal RT1 and a connector CN.

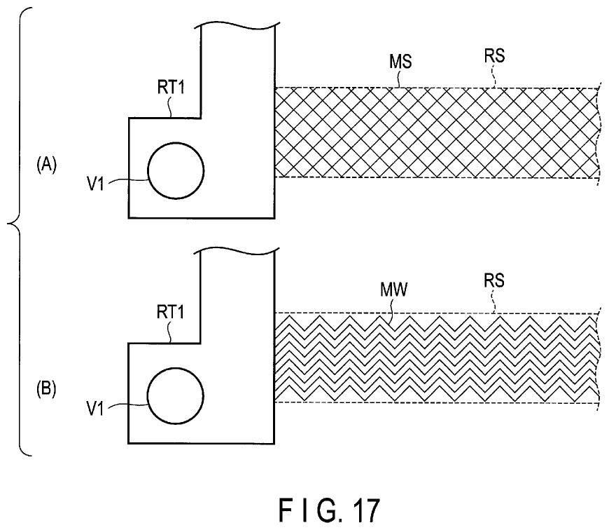

The detector RS is located in the display area DA and extends in the first direction X. In the detection electrode Rx1, mainly, the detector RS is used for sensing. In the example illustrated, the detector RS is formed in a strip shape, and more specifically, the detector RS is formed of an aggregate of thin metal wires as will be described with reference to FIG. 17. Furthermore, one detection electrode Rx1 comprises two detectors RS but may comprise three or more detectors RS or only one detector RS.

The terminal RT1 is located on one end side in the first direction X of the non-display area NDA and is connected to the detectors RS. The connector CN is located on the other end side in the first direction X of the non-display area NDA and connects the detectors RS to each other. In FIG. 13, one end side corresponds to the left side of the display area DA and the other end side corresponds to the right side of the display area DA. A part of the terminal RT1 is formed at a position overlapping the sealing SE when planarly viewed.

On the other hand, the first substrate SUB1 comprises a pad P1 corresponding to the above-described first conductive layer L1 and a wiring line W1 corresponding to the above-described wiring line CL. The pad P1 and the wiring line W1 are located on one end side of the non-display area NDA and overlap the sealant SE when planarly viewed. The pad P1 is formed at a position overlapping the terminal RT1 when planarly viewed. The wiring line W1 is connected to the pad P1, extends in the second direction Y, and is electrically connected to the detection circuit RC of the IC chip I1 via the wiring substrate SUB3.

A contact hole V1 is located in the non-display area NDA and is formed at a position at which the terminal RT1 and the pad P1 are opposed to each other. In addition, the contact hole V1 penetrates the second substrate SUB2 and the sealant SE. As described with reference to FIG. 1, etc., the connecting material C is provided in the contact hole V1. As a result, the terminal RT1 and the pad P1 are electrically connected to each other. That is, the detection electrode Rx1 provided in the second substrate SUB2 is electrically connected to the detection circuit RC via the wiring substrate SUB3 connected to the first substrate SUB1. The detection circuit RC reads a sensor signal output from the detection electrode Rx and detects the presence or absence of contact or approach of an object to be detected, the position coordinates of an object to be detected, and the like.

In the example illustrated, the terminals RT1, RT3 . . . of odd-numbered detection electrodes Rx1, Rx3 . . . , pads P1, P3 . . . , wiring lines W1, W3 . . . , and contact holes V1, V3 . . . are all located on one end side of the non-display area NDA. In addition, the terminals RT2, RT4 . . . of even-numbered detection electrodes Rx2, Rx4 . . . , pads P2, P4 . . . , wiring lines W2, W4 . . . , contact holes V2, V4 . . . are all located on the other end side of the non-display area NDA. According to such a layout, the width on one end side and the width on the other end side of the non-display area NDA can be made uniform, which is suitable for narrowing the frame.

In a layout in which the pad P3 is closer to the wiring substrate SUB3 than the pad P1 is to the wiring substrate SUB3, as illustrated in the drawing, the wiring line W1 detours around the pad P3 on the inner side of the pad P3 (that is, the side close to the display area DA), and the wiring line W1 is disposed on the inner side of the wiring line W3 between the pad P3 and the wiring substrate SUB3. Similarly, the wiring line W2 detours around the pad P4 on the inner side of the pad P4, and the wiring line W2 is disposed on the inner side of the wiring line W4 between the pad P4 and the wiring substrate SUB3.

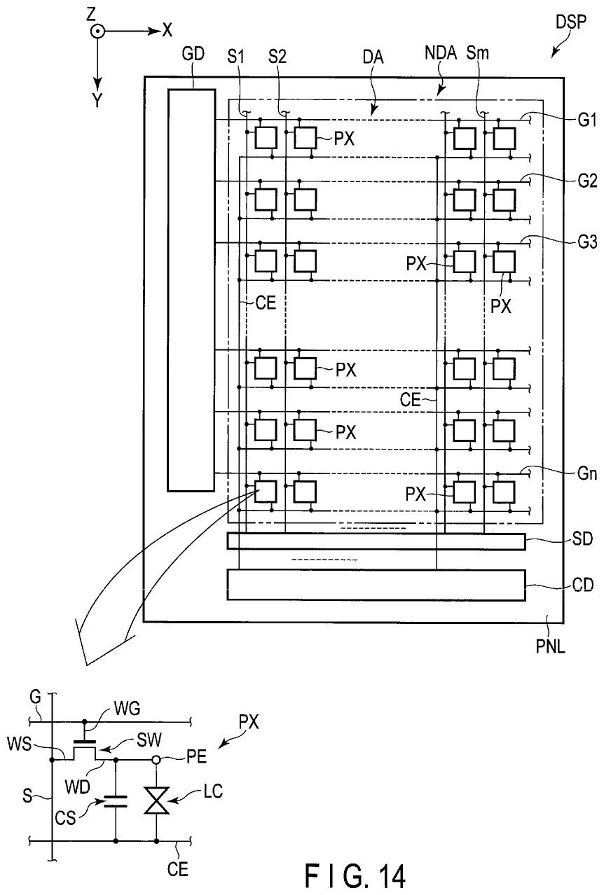

FIG. 14 is an illustration showing the basic configuration and equivalent circuit of the display panel PNL shown in FIG. 13.

The display panel PNL comprises a plurality of pixels PX in the display area DA. The term pixel here indicates a minimum unit which can be individually controlled in accordance with a pixel signal, and exists in, for example, an area including a switching element disposed at a position at which a scanning line and a signal line, which will be described later, cross each other. The pixels PX are arranged in a matrix in the first direction X and the second direction Y. In addition, the display panel PNL comprises a plurality of scanning lines G (G1 to Gn), a plurality of signal lines S (S1 to Sm), a common electrode CE and the like in the display area DA. The scanning lines G extend in the first direction X and are arranged in the second direction Y. The signal lines S extend in the second direction Y and are arranged in the first direction X. The scanning lines G and the signal lines S may not extend linearly but may be partially bent. The common electrode CE is arranged across the pixels PX. The scanning lines the signal lines S and the common electrode CE are drawn to the non-display area NDA. In the non-display area NDA, the scanning lines G are connected to the scanning line drive circuit GD, the signal lines S are connected to the signal line drive circuit SD, and the common electrode CE is connected to the common electrode drive circuit CD. The signal line drive circuit SD, the scanning line drive circuit GD and the common electrode drive circuit CD may be formed on the first substrate SUB1 or may be partially or entirely incorporated in the IC chip I1 shown in FIG. 13.

Each pixel PX comprises a switching element SW, a pixel electrode PE, a common electrode CE, a liquid crystal layer LC and the like. The switching element SW is composed of a thin-film transistor (TFT), for example, and is electrically connected to a scanning line G and a signal line S. More specifically, the switching element SW comprises a gate electrode WG, a source electrode WS and a drain electrode WD. The gate electrode WG is electrically connected to the scanning line G In the example illustrated, the electrode electrically connected to the signal line S is referred to as the source electrode WS and the electrode electrically connected to the pixel electrode PE is referred to as the drain electrode WD.

Each scanning line G is connected to the switching elements SW in the respective pixels PX arranged in the first direction X. Each signal line S is connected to the switching elements SW in the respective pixels PX arranged in the second direction Y. Each pixel electrode PE is opposed to the common electrode CE and drives the liquid crystal layer LC by an electric field produced between the pixel electrode PE and the common electrode CE. A storage capacitance CS is formed between the common electrode CE and the pixel electrode PE, for example.

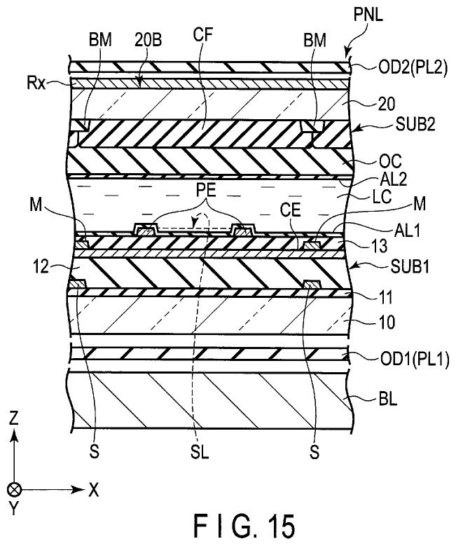

FIG. 15 is a cross-sectional view showing the structure of a part of the display panel PNL shown in FIG. 13. The figure is a cross-sectional view of the display device DSP taken in the first direction X.

The illustrated display panel PNL has a configuration corresponding to a display mode which mainly uses a lateral electric field substantially parallel to the surface of a substrate. Note that the display panel PNL may have a configuration corresponding to a display mode which uses a longitudinal electric field perpendicular to the surface of a substrate, an oblique electric field inclined with respect to the surface of a substrate, or a combination of them. In the display mode using the lateral electric field, it is possible to apply such a configuration that one of the first substrate SUB1 and the second substrate SUB2 comprises both the pixel electrode PE and the common electrode CE, for example. In the display mode using the longitudinal electric field or the oblique electric field, it is possible to apply such a configuration that the first substrate SUB1 comprises one of the pixel electrode PE and the common electrode CE and the second substrate SUB2 comprises the other one of the pixel electrode PE and the common electrode CE, for example. Note that the surface of a substrate described here is a surface parallel to the X-Y plane.

The first substrate SUB1 comprises a first insulating substrate 10, a signal line S, a common electrode CE, a metal layer M, a pixel electrode PE, a first insulating film 11, a second insulating film 12, a third insulating film 13, a first alignment film AL1 and the like. Note that a switching element, a scanning line, various insulating films interposed between them, and the like are not illustrated in the drawing.

The first insulating film 11 is located on the first insulating substrate 10. The scanning line and a semiconductor layer of the switching element which are not illustrated in the drawing are located between the first insulating substrate 10 and the first insulating film 11. The signal line S is located on the first insulating film 11. The second insulating film 12 is located on the signal line S and the first insulating film 11. The common electrode CE is located on the second insulating film 12. The metal layer M is in contact with the common electrode CE directly above the signal line S. The metal layer M is located on the common electrode CE in the example illustrated but may be located between the common electrode CE and the second insulating film 12. The third insulating film 13 is located on the common electrode CE and the metal layer M. The pixel electrode PE is located on the third insulating film 13. The pixel electrode PE is opposed to the common electrode CE via the third insulating film 13. In addition, the pixel electrode PE has a slit SL at a position opposed to the common electrode CE. The first alignment film AL1 covers the pixel electrode PE and the third insulating film 13.

Each of the scanning line, the signal line S and the metal layer M is formed of a metal material such as molybdenum, tungsten, titanium or aluminum and may have a single-layer structure or a multilayer structure. Each of the common electrode CE and the pixel electrode PE may be formed of a transparent conductive material such as ITO or IZO. The first insulating film 11 is an inorganic insulating film formed of silicon nitride (SiN), silicon oxide (SiO) or the like, and may be a single-layer film formed of either one or a multilayer film formed of stacked inorganic insulating films. The second insulating film 12 is an organic insulating film formed of acrylic resin or the like. The third insulating film 13 is an inorganic insulating film formed of silicon nitride (SiN).

The configuration of the first substrate SUB1 is not limited to the example illustrated, and the pixel electrode PE may be located between the second insulating film 12 and the third insulating film 13 and the common electrode CE may be located between the third insulating film 13 and the first alignment film AL1. In this case, the pixel electrode PE is formed in a plate shape having no slit and the common electrode CE has a slit opposed to the pixel electrode PE. Alternatively, the pixel electrode PE and the common electrode CE may be formed in a comb-tooth shape and may be arranged to be engaged with each other.

The second substrate SUB2 comprises a second insulating substrate 20, a light-shielding layer BM, a color filter CF, a second alignment film AL2 and the like.

The light-shielding layer BM and the color filter CF are located on a side of the second insulating substrate 20 which is opposed to the first substrate SUB1. The light-shielding layer BM delimits each pixel and is located directly above the signal line S. The color filter CF is opposed to the pixel electrode PE and partially overlaps the light-shielding layer BM. The color filter CF includes a red color filter, a green color filter, a blue color filter and the like. The overcoat layer OC covers the color filter CF. The second alignment film AL2 covers the overcoat layer OC.

Note that the color filter CF may be disposed in the first substrate SUB1. The color filter CF may include color filters of four or more colors. For a pixel which shows white, a white color filter or an uncolored resin material may be disposed or the overcoat layer OC may be disposed without any color filter.

The detection electrode Rx is located on the surface 20B of the second insulating substrate 20. The detection electrode Rx may be formed of a conductive layer including metal or a transparent conductive material such as ITO or IZO, may be formed by stacking a transparent conductive layer on a conductive layer including metal, or may be formed of a conductive organic material, a dispersing element of a fine conductive substance or the like.

A first optical element OD1 including a first polarizer PL1 is located between the first insulating substrate 10 and an illuminating device BL. A second optical element OD2 including a second polarizer PL2 is located on the detection electrode Rx. Each of the first optical element OD1 and the second optical element OD2 may include a retardation film as needed.

For example, the pixel electrode PE can be located in the same layer as the above-described first conductive layer L1 and can be formed of the same material as the first conductive layer L1. The detection electrode Rx can be located in the same layer as the above-described second conductive layer L2 and can be formed of the same material as the second conductive layer L2. The light-shielding layer BM and the overcoat layer OC are disposed not only in the display area shown in FIG. 15 but also in the non-display area on the outside and are included in the above-described insulating film OI.

Next, a configuration example of the sensor SS provided in the display device DSP of the present embodiment will be described. The sensor SS which will be described below is a mutual capacitance type electrostatic capacitive sensor, for example, and detects contact or approach of an object to be detected based on a change in the electrostatic capacitance between a pair of electrodes which are opposed to each other via a dielectric.

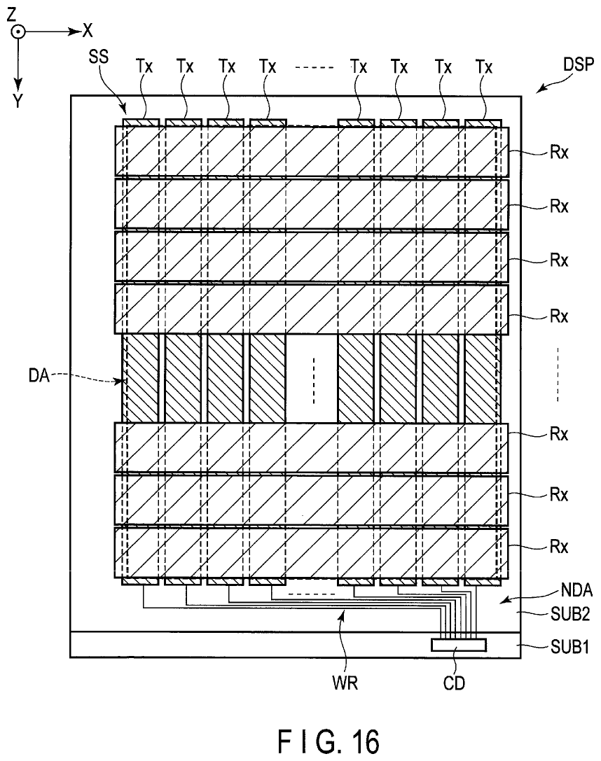

FIG. 16 is a plan view showing a configuration example of the sensor SS.

In the configuration example illustrated, the sensor SS comprises a sensor drive electrode Tx and a detection electrode Rx. In the example illustrated, the sensor drive electrode Tx corresponds to a portion indicated by diagonal lines slanting downward to the right and is provided in the first substrate SUB1. In addition, the detection electrode Rx corresponds to a portion indicated by diagonal lines slanting upward to the right and is provided in the second substrate SUB2. The sensor drive electrode Tx and the detection electrode Rx cross each other in the X-Y plane. The detection electrode Rx is opposed to the sensor drive electrode Tx in the third direction Z.

The sensor drive electrode Tx and the detection electrode Rx are located in the display area DA and partially extend in the non-display area NDA. In the example illustrated, the sensor drive electrodes Tx are formed in a strip shape extending in the second direction Y and are arranged to be spaced apart from each other in the first direction X. The detection electrodes Rx extend in the first direction X and are arranged to be spaced apart from each other in the second direction Y As described with reference to FIG. 13, each detection electrode Rx is connected to a pad provided in the first substrate SUB1 and is electrically connected to the detection circuit RC via a wiring line. Each sensor drive electrode Tx is electrically connected to the common electrode drive circuit CD via a wiring line. Note that the number, size and shape of the sensor drive electrodes Tx and the detection electrodes Rx are not particularly limited but can be variously changed.

The sensor drive electrode Tx includes the above-described common electrode CE, and has the function of producing an electric field between the sensor drive electrode Tx and the pixel electrode PE and also has the function of detecting the position of an object to be detected by producing a capacitance between the sensor drive electrode Tx and the detection electrode Rx.

The common electrode drive circuit CD supplies a common drive signal to the sensor drive electrode Tx including the common electrode CE at a display drive time of displaying an image in the display area DA. In addition, the common electrode drive circuit CD supplies a sensor drive signal to the sensor drive electrode Tx at a sensing drive time of performing sensing. In accordance with the supply of the sensor drive signal to the sensor drive electrode Tx, the detection electrode Rx outputs a sensor signal necessary for sensing (that is, a signal based on a change in the interelectrode capacitance between the sensor drive electrode Tx and the detection electrode Rx). The detection signal output from the detection electrode Rx is input to the detection circuit RC shown in FIG. 13.

Note that the sensor SS in each of the above-described configuration examples may not be a mutual-capacitive sensor which detects an object to be detected based on a change in the electrostatic capacitance between a pair of electrodes (in the above-described example, the electrostatic capacitance between the sensor drive electrode Tx and the detection electrode Rx) but may be a self-capacitive sensor which detects an object to be detected based on a change in the electrostatic capacitance of the detection electrode Rx.

FIG. 17 is an illustration showing a configuration example of the detector RS of the detection electrode Rx1 shown in FIG. 13.

In the example shown in FIG. 17 (A), the detector RS is formed of thin metal wires MS which constitute a mesh. The thin metal wires MS are connected to the terminal RT1. In the example shown in FIG. 17 (B), the detector RS is formed of wavy thin metal wires MW. The thin metal wires MW are formed in a sawtooth shape in the example illustrated but may be formed in another shape such as a sine-wave shape. The thin metal wires MW are connected to the terminal RT1.

The terminal RT1 is formed of the same material as the detector RS, for example. In the terminal RT1, a contact hole V1 having a circular shape when planarly viewed is formed.

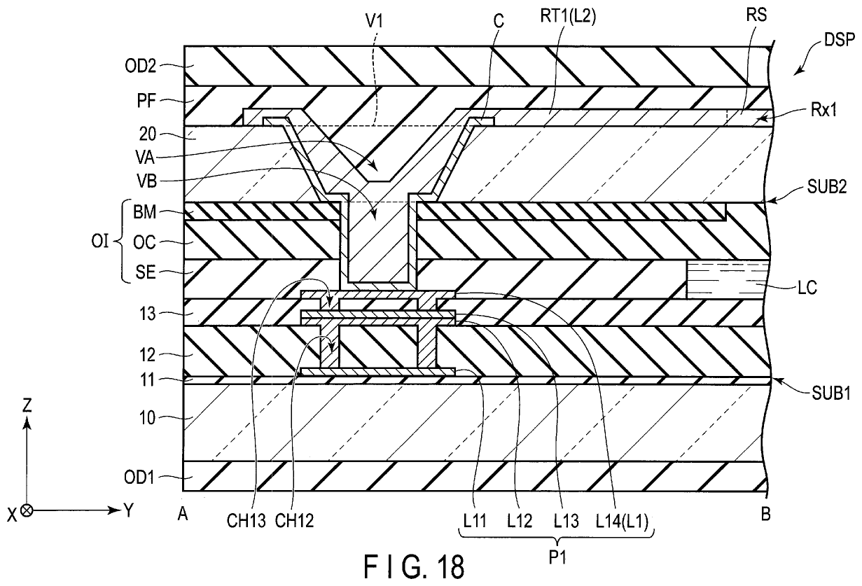

FIG. 18 is a cross-sectional view showing a configuration example of the display panel PNL taken along line A-B including the contact hole V1 shown in FIG. 13.

The first substrate SUB1 comprises the first insulating substrate 10, the pad P1, the first insulating film 11, the second insulating film 12, the third insulating film 13 and the like. In the example illustrated, the pad P1 comprises a first layer L11, a second layer L12, a third layer L13 and a fourth layer L14. The first layer L11 is located between the first insulating film 11 and the second insulating film 12. The second layer L12 and the third layer L13 are located between the second insulating film 12 and the third insulating film 13. The second layer L12 is in contact with the first layer L11 via a contact hole CH12 which penetrates the second insulating film 12. The third layer L13 is located on the second layer L12 and is in contact with the second layer L12. The fourth layer L14 is located between the third insulating film 13 and the sealant SE. The fourth layer L14 is in contact with the third layer L13 via a contact hole CH13 which penetrates the third insulating film 13. Regarding the correspondences between the members shown in FIG. 15 and the first to fourth layers L11 to L14, the first layer L11 can be located in the same layer as the signal line S and can be formed of the same material as the signal line S. The second layer L12 can be located in the same layer as the common electrode CE and can be formed of the same material as the common electrode CE. The third layer L13 can be located in the same layer as the metal layer M and can be formed of the same material as the metal layer M. The fourth layer L14 can be located in the same layer as the pixel electrode PE and can be formed of the same material as the pixel electrode PE. Note that the wiring line W1 and the like described with reference to FIG. 13 can be located in the same layer as the first layer L11 and can be formed of the same material as the first layer L11.

The second substrate SUB2 comprises the second insulating substrate 20, the detection electrode Rx1, the light-shielding layer BM, the overcoat layer OC and the like.

The sealant SE is located between the third insulating film 13 and the overcoat layer OC and between the fourth layer L14 and the overcoat layer OC.

In the above configuration example, for example, the fourth layer L14 corresponds to the first conductive layer L1, the terminal RT1 corresponds to the second conductive layer L2, and the sealant SE, the overcoat layer OC and the light-shielding layer BM correspond to the insulating film OI.

The contact hole V1 includes the through hole VA which penetrates the second insulating substrate 20 and the through hole VB which penetrates the insulating film OI. The connecting material C is provided in the contact hole V1 and electrically connects the pad P1 and the detection electrode Rx. Members which are in contact with the connecting material C in the contact hole V1 will be more specifically described. That is, the connecting material C is in contact with each of the terminal RT1 and the second insulating substrate 20 in the through hole VA. Further, the connecting material C is in contact with each of the light-shielding layer BM, the overcoat layer OC and the sealant SE in the through hole VB and is in contact with the fourth layer L14 of the pad P1.

According to the display device DSP comprising the above-described sensor SS, the detection electrode Rx provided in the second substrate SUB2 is connected to the pad P provided in the first substrate SUB1 by the connecting material C provided in the contact hole V. Therefore, it becomes unnecessary to mount a wiring substrate for connecting the detection electrode Rx and the detection circuit RX on the second substrate SUB2. That is, the wiring substrate SUB3 mounted on the first substrate SUB1 forms a transmission path for transmitting a signal necessary for displaying an image on the display panel PNL and also forms a transmission path for transmitting a signal between the detection electrode Rx and the detection circuit RC. Consequently, as compared to a configuration example which requires another wiring substrate separately from the wiring substrate SUB3, the number of wiring substrates can be reduced and the cost can be reduced. In addition, since the space for connecting a wiring substrate to the second substrate SUB2 is not required, the width of the non-display area of the display panel PNL, in particular, the end side on which the wiring substrate SUB3 is mounted can be reduced. Accordingly, it is possible to achieve a narrow frame and cost reduction.

Furthermore, the third insulating film 13 formed of silicon nitride (SiN) is disposed directly below the contact hole V. When a laser beam is focused to a portion within the second insulating substrate 20 at the time of forming the through hole VA in the second insulating substrate 20, even if the emitted laser beam is transmitted through the insulating film OI, the laser beam can be absorbed by the third insulating film 13 located directly below. As a result, it is possible to reduce the influence of the transmission of the laser beam on other members.

As described above, according to the present embodiment, an electronic device which can achieve a narrow frame and cost reduction and a method for manufacturing the same can be provided.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

An example of the display device obtained from the configuration disclosed in the present specification will be additionally described below.

(1)

An electronic device comprising:

a first substrate comprising a first insulating substrate and a first conductive layer;

a second substrate comprising
a second insulating substrate having a first surface which is opposed to the first conductive layer and is separated from the first conductive layer and a second surface which is located on an opposite side to the first surface, and
a second conductive layer located on the second surface, and

the second substrate having a first through hole penetrating the first surface and the second surface;

an insulating film located between the first conductive layer and the second insulating substrate and having a second through hole which is connected to the first through hole and penetrates to the first conductive layer; and

a connecting material located in the first through hole and the second through hole and electrically connecting the first conductive layer and the second conductive layer, wherein

a width of the second through hole is less than a width of the first through hole.

(2)

The electronic device according to (1), wherein

the first through hole comprises a first portion located in the first surface and a second portion located in the second surface, and

the insulating film comprises a ring-shaped first upper surface which is located between an edge of the first portion and the second through hole and is in contact with at least one of the connecting material and the second conductive layer.

(3)

The electronic device according to (2), wherein the first portion and the second portion are concentrically formed in planar view.

(4)

The electronic device of any one according to (1) to (3), wherein the first conductive layer comprises a circular second upper surface which is in contact with at least one of the connecting material and the second conductive layer.

(5)

The electronic device of any one according to (1) to (4), wherein the connecting material is located between the second insulating substrate and the second conductive layer in the first through hole.

(6)

The electronic device of any one according to (1) to (4), wherein the second conductive layer is located between the second insulating substrate and the connecting material in the first through hole.

(7)

The electronic device of any one according to (1) to (6), wherein

the second substrate comprises a detector which detects contact or approach of an object to be detected, and

the second conductive layer is connected to the detector.

(8)

The electronic device according to (7), further comprising a detection circuit which is electrically connected to the first conductive layer and reads a sensor signal output from the second conductive layer.

(9)

The electronic device according to (7) or (8), wherein the first substrate comprises a sensor drive electrode which crosses the detector.

(10)

The electronic device of any one according to (7) to (9), wherein

the detector is located in a display area in which a plurality of pixels are disposed, and

the first through hole and the second through hole are located in a non-display area which surrounds the display area.

(11)

A method for manufacturing an electronic device, the method comprising;

in a workpiece comprising
a first substrate comprising a first insulating substrate and a first conductive layer,
a second substrate comprising a second insulating substrate, and
an insulating film located between the first conductive layer and the second insulating substrate,

modifying by focusing a laser beam to an area within the second insulating substrate;

forming a first through hole which penetrates the second insulating substrate to the insulating film by thinning the second insulating substrate, removing the modified area; and

forming a second through hole which is connected to the first through hole and penetrates the insulating film to the first conductive layer.

(12)

The method for manufacturing the electronic device according to (11), wherein the laser beam is a femtosecond laser beam having a pulse width of femtoseconds.

(13)

The method for manufacturing the electronic device according to (11) or (12), wherein

the modifying by focusing the laser beam comprises modifying by focusing the laser beam to each of an area at a first position and an area at a second position different from the first position within the second insulating substrate.

(14)

The method for manufacturing the electronic device of any one according to (11) to (13), wherein the thinning the second insulating substrate comprises etching the first insulating substrate and the second insulating substrate and reducing the first insulating substrate and the second insulating substrate in thickness.

(15)

The method for manufacturing the electronic device of any one according to (11) to (14), wherein each of the first insulating substrate and the second insulating substrate is a glass substrate.

(16)

The method for manufacturing the electronic device of any one according to (11) to (15), wherein the forming the second through hole is accomplished by emitting a laser beam.

(17)

The method for manufacturing the electronic device of any one according to (11) to (16), further comprising:

after forming the second through hole,

forming a connecting material which is located in the first through hole and the second through hole and is in contact with the first conductive layer, and

forming a second conductive layer which is in contact with the connecting material.

(18)

The method for manufacturing the electronic device of any one according to (11) to (16), further comprising:

after forming the second through hole,

forming a second conductive layer which is located in the first through hole and the second through hole and is in contact with the first conductive layer.

What is claimed is:

1. An electronic device comprising:
a first substrate comprising a first insulating substrate and a first conductive layer;
a second substrate comprising
a second insulating substrate having a first surface which is opposed to the first conductive layer and is separated from the first conductive layer and a second surface which is located on an opposite side to the first surface, and
a second conductive layer located on the second surface, and
the second substrate having a first through hole penetrating the first surface and the second surface;
an insulating film located between the first conductive layer and the second insulating substrate and having a second through hole which is connected to the first through hole and penetrates to the first conductive layer; and
a connecting material located in the first through hole and the second through hole and electrically connecting the first conductive layer and the second conductive layer, wherein
a width of the second through hole is less than a width of the first through hole.

2. The electronic device according to claim 1, wherein
the first through hole comprises a first portion located in the first surface and a second portion located in the second surface, and
the insulating film comprises a ring-shaped first upper surface which is located between an edge of the first portion and the second through hole and is in contact with at least one of the connecting material and the second conductive layer.

3. The electronic device according to claim 2, wherein the first portion and the second portion are concentrically formed in planar view.

4. The electronic device according to claim 1, wherein the first conductive layer comprises a circular second upper surface which is in contact with at least one of the connecting material and the second conductive layer.

5. The electronic device according to claim 1, wherein the connecting material is located between the second insulating substrate and the second conductive layer in the first through hole.

6. The electronic device according to claim 1, wherein the second conductive layer is located between the second insulating substrate and the connecting material in the first through hole.

7. The electronic device according to claim 1, wherein
the second substrate comprises a detector which detects contact or approach of an object to be detected, and
the second conductive layer is connected to the detector.

8. The electronic device according to claim 7, further comprising a detection circuit which is electrically connected to the first conductive layer and reads a sensor signal output from the second conductive layer.

9. The electronic device according to claim 7, wherein the first substrate comprises a sensor drive electrode which crosses the detector.

10. The electronic device according to claim 7, wherein
the detector is located in a display area in which a plurality of pixels are disposed, and
the first through hole and the second through hole are located in a non-display area which surrounds the display area.

11. A method for manufacturing an electronic device, the method comprising;
in a workpiece comprising
a first substrate comprising a first insulating substrate and a first conductive layer,
a second substrate comprising a second insulating substrate, and
an insulating film located between the first conductive layer and the second insulating substrate,
modifying by focusing a laser beam to an area within the second insulating substrate;
forming a first through hole which penetrates the second insulating substrate to the insulating film by thinning the second insulating substrate, removing the modified area; and
forming a second through hole which is connected to the first through hole and penetrates the insulating film to the first conductive layer.

12. The method for manufacturing the electronic device according to claim 11, wherein the laser beam is a femtosecond laser beam having a pulse width of femtoseconds.

13. The method for manufacturing the electronic device according to claim 11, wherein
the modifying by focusing the laser beam comprises modifying by focusing the laser beam to each of an area at a first position and an area at a second position different from the first position within the second insulating substrate.

14. The method for manufacturing the electronic device according to claim 11, wherein the thinning the second insulating substrate comprises etching the first insulating substrate and the second insulating substrate and reducing the first insulating substrate and the second insulating substrate in thickness.

15. The method for manufacturing the electronic device according to claim 11, wherein each of the first insulating substrate and the second insulating substrate is a glass substrate.

16. The method for manufacturing the electronic device according to claim 11, wherein the forming the second through hole is accomplished by emitting a laser beam.

17. The method for manufacturing the electronic device according to claim 11, further comprising:
after forming the second through hole,
forming a connecting material which is located in the first through hole and the second through hole and is in contact with the first conductive layer, and
forming a second conductive layer which is in contact with the connecting material.

18. The method for manufacturing the electronic device according to claim 11, further comprising:
after forming the second through hole,
forming a second conductive layer which is located in the first through hole and the second through hole and is in contact with the first conductive layer.
